(19) United States
(12) Patent Application Publication
(10) Pub. No.: US 2014/0356028 A1
(43) Pub. Date: Dec. 4, 2014

(54) LIQUID DEVELOPING DEVICE AND IMAGE FORMING APPARATUS

(71) Applicant: FUJI XEROX CO., LTD., Tokyo (JP)

(72) Inventors: Yuki YOKOYAMA, Kanagawa (JP); Yutaka NOGAMI, Kanagawa (JP)

(73) Assignee: FUJI XEROX CO., LTD., Tokyo (JP)

(21) Appl. No.: 14/086,349

(22) Filed: Nov. 21, 2013

(30) Foreign Application Priority Data
May 31, 2013 (JP) 2013-116037

(51) Int. Cl. G03G 15/10

(52) U.S. Cl. CPC G03G 15/105
USPC 399/237

(57) ABSTRACT

A liquid developing device includes a developer accommodating section that accommodates a liquid developer containing a toner and a carrier liquid and having a toner concentration of from 23 to 27 vol %; a developing member to which the liquid developer accommodated in the developer accommodating section is supplied to a surface thereof to form a liquid developer layer with a thickness of from 5.8 to 7.5 μm, of which a toner coverage is from 0.71 to 1.1, and the liquid developer layer thus formed is supplied to a surface of an image holding member to develop an electrostatic latent image formed on the surface of the image holding member to thus form a toner image; and a developer charging unit that charges the liquid developer layer before the liquid developer layer is supplied to the surface of the image holding member.

### CROSS-REFERENCE TO RELATED APPLICATIONS

This application is based on and claims priority under 35 USC 119 from Japanese Patent Application No. 2013-116037 filed May 31, 2013.

### BACKGROUND

1. Technical Field

The present invention relates to a liquid developing device and an image forming apparatus.

2. Related Art

Hitherto, wet image formation in which a liquid developer is supplied to a surface of an image holding member from a liquid developer layer formed on a developing member to develop an electrostatic latent image on the surface of the image holding member with a toner has been performed.

### SUMMARY

According to an aspect of the invention, there is provided a liquid developing device including:

a developer accommodating section that accommodates a liquid developer containing a toner and a carrier liquid and having a toner concentration of from 23 vol % to 27 vol %;

a developing member to which the liquid developer accommodated in the developer accommodating section is supplied to a surface thereof to form a liquid developer layer with a thickness of from 5.8 μm to 7.5 μm, of which a toner coverage that is obtained through the following expression (1) is from 0.71 to 1.1, and the liquid developer layer thus formed is supplied to a surface of an image holding member to develop an electrostatic latent image formed on the surface of the image holding member to thus form a toner image; and

a developer charging unit that charges the liquid developer layer before the liquid developer layer is supplied to the surface of the image holding member,

Toner Coverage=({S_{V}L/(4πr³/3)}×πr²)/0.9069 Expression (1):

wherein in the expression (1), S_{V} represents a toner concentration (vol %/100) in the liquid developer; L represents a thickness (μm) of the liquid developer layer; and r represents a volume average particle radius (μm) of the toner; 0.9069 that is the above numerical value is a closest area filling rate of circles.

### BRIEF DESCRIPTION OF THE DRAWINGS

Exemplary embodiments of the present invention will be described in detail based on the following FIGURE, wherein:

FIG. 1 is a schematic diagram illustrating a configuration of an image forming apparatus according to an exemplary embodiment.

### DETAILED DESCRIPTION

Hereinafter, exemplary embodiments of the invention will be described in detail.

A liquid developing device according to an exemplary embodiment includes a developer accommodating section that accommodates a liquid developer containing a toner and a carrier liquid, and a developing member in which the liquid developer accommodated in the developer accommodating section is supplied to a surface thereof to form a liquid developer layer, and the liquid developer layer thus formed is supplied to a surface of an image holding member to develop an electrostatic latent image formed on the surface of the image holding member to thus form a toner image.

A toner concentration in the liquid developer is from 23 vol % to 27 vol %.

A thickness of the liquid developer layer formed on the surface of the developing member is from 5.8 μm to 7.5 μm.

In the liquid developer layer, a toner coverage that is obtained through the following expression (1) is controlled to be from 0.71 to 1.1.

The liquid developing device according to this exemplary embodiment further includes a developer charging unit that charges the liquid developer layer before the liquid developer layer is supplied to the surface of the image holding member.

Toner Coverage=({S_{V}L/(4πr³/3)}×πr²)/0.9069 Expression (1):

In the expression (1), S_{V} represents a toner concentration (vol %/100) in the liquid developer, L represents a thickness (μm) of the liquid developer layer, and r represents a volume average particle radius (μm) of the toner, 0.9069 that is the above numerical value is a closest area filling rate of circles.

Hitherto, wet image formation in which a liquid developer is supplied to a surface of an image holding member from a liquid developer layer formed on a developing member to develop an electrostatic latent image on the surface of the image holding member with the toner has been performed. In this image formation, in an aspect in which the toner itself in the liquid developer that is accommodated in the developer accommodating section is previously charged, the toner overlaps in a direction perpendicular to the developing member in the liquid developer supplied to the surface of the developing member, and as a result, a place in which toner particles are concentrated may be caused in the liquid developer, and thus an uneven toner layer may be formed.

In addition, in the wet image formation using the liquid developer, voids may occur in the image part or the toner may be moved to a region (non-image part) other than the part in which the electrostatic latent image is formed, and thus fogging may occur or irregularities may be caused in contour parts of dots.

However, the liquid developing device according to this exemplary embodiment includes the developer charging unit that charges the liquid developer layer before the liquid developer layer is supplied to the surface of the image holding member. In addition, the toner concentration in the liquid developer is controlled to be from 23 vol % to 27 vol %, the thickness of the liquid developer layer formed on the surface of the developing member is controlled to be from 5.8 μm to 7.5 μm, and the toner coverage that is obtained through the expression (1) is controlled to be from 0.71 to 1.1. In this exemplary embodiment, since this configuration is provided, an image having excellent image quality is formed.

The mechanism by which this effect occurs is not necessarily clear, but is presumed as follows.

First, since the developer charging unit that charges the liquid developer layer before the liquid developer layer is supplied to the surface of the image holding member is provided, the toner is charged and pushed toward the developing member in the liquid developer. The reason for this is thought to be that since the developer charging unit continuously further charges the toner that has been charged at the front part of the region in which the developer charging unit performs charging, the charged toner reacts thereagainst and is moved toward the developing member in the liquid developer.

However, even though the developer charging unit is provided, when the above-described toner coverage is low, the toner amount is insufficient, and thus it is thought that a part in which no toner layer is formed is caused in the liquid developer layer on the surface of the developing member, and as a result, voids occur in the image part. On the other hand, when the toner coverage is high, the toner amount is too large, and thus plural toner layers are formed in the liquid developer layer on the surface of the developing member, and the farther the toner of the toner layer is from the developing member, the weaker the adhesion to the developing member is. Accordingly, it is thought that the toner is moved to a region (non-image part) other than a part in which the electrostatic latent image is formed, and as a result, fogging occurs or irregularities are caused in contour parts of dots.

However, when the toner coverage is controlled to be within the above range, the toner is present in an appropriate amount in the liquid developer layer. Accordingly, it is thought that the occurrence of voids in the image part, the occurrence of fogging, and irregularities in contour parts of dots are suppressed.

In addition, since the developer charging unit is provided and the toner coverage is controlled to be within the above range, it is thought that unevenness is suppressed in the liquid developer layer on the surface of the developing member and a toner layer in which overlap of plural layers is suppressed is formed, and thus an image having excellent image quality is formed.

Toner Coverage

The toner coverage in the liquid developer layer formed on the developing member is from 0.71 to 1.1 as described above.

When the toner coverage is less than 0.71, voids occur in the image part. On the other hand, when the toner coverage is more than 1.1, the toner is moved to a region (non-image part) other than the part in which the electrostatic latent image is formed, and thus fogging occurs or irregularities are caused in contour parts of dots.

In this exemplary embodiment, the toner coverage is expressed by the expression (1).

Here, the toner concentration in the liquid developer that is represented by S_{V} in expression (1) is measured using the following method.

First, the accommodated liquid developer is taken out of the developer accommodating unit. A bottle including a developer resulting from the dilution of the liquid developer to 600 times is dipped in a small-sized ultrasonic washing machine to disperse particles. Thereafter, the diluted liquid developer is deaerated, and then measured for absorbance using an absorptiometer (manufactured by Shimadzu Corporation, UV-2500PC). The original developer concentration is calculated from the measured absorbance, and a previously created standard curve of the absorbance and the concentration of the diluted developer.

The thickness (μm) of the liquid developer layer that is represented by L in expression (1) is measured using the following method.

The liquid developer adhering to a surface on a certain area of the developing member that forms an image using the liquid developer supplied from the developer accommodating section is wiped with a waste cloth or the like, and a change in mass of the waste cloth between before and after the wiping is measured to measure a mass of the wiped liquid developer. The thickness is obtained through the following expression from the measured liquid developer mass, the wiped area, the toner concentration of the liquid developer, the specific gravity of the toner, and the specific gravity of the carrier.

Thickness=(M×(S/T+(1−S)/C))/A Expression (2):

In the expression (2), M represents a mass (g) of the liquid developer, S represents a toner concentration (wt %) of the liquid developer, T represents a specific gravity of the toner, C represents a specific gravity of the carrier liquid, and A represents a wiped area (m²).

The volume average particle radius (μm) of the toner that is represented by r in expression (1) is measured using the following method.

First, a volume average particle diameter D50_{V} of the toner is measured. The measurement is performed using a laser diffraction/scattering-type particle size distribution measurement device (for example, LA920 (manufactured by Horiba, Ltd.)). A cumulative distribution is drawn for volume from the smallest diameter side with respect to particle size ranges (channels) divided based on the particle size distribution, and a particle diameter when the cumulative percentage becomes 50% is defined as the volume average particle diameter D50_{V}.

A volume average particle radius of the toner is calculated by dividing the obtained volume average particle diameter D50_{V} by 2.

The numerical values described herein are values measured using the above-described methods.

Toner Concentration

The toner concentration in the liquid developer is from 23 vol % to 27 vol %. When the toner concentration is less than 23 vol %, the toner amount is insufficient, and thus voids are caused in the image part. On the other hand, when the toner concentration is more than 27 vol %, the toner amount is too large, and thus fogging occurs or irregularities are caused in contour parts of dots.

The toner concentration in the liquid developer is controlled with a ratio of the toner to the carrier liquid during the preparation of the liquid developer.

Thickness of Liquid Developer Layer

The thickness (L) of the liquid developer layer is from 5.8 μm to 7.5 μm. When the thickness is less than 5.8 μm, the toner amount is insufficient, and thus voids are caused in the image part. On the other hand, when the thickness is more than 7.5 μm, linear disturbance occurs in the image due to the liquid flowing during the developing.

The thickness of the liquid developer layer is controlled with a viscosity of the liquid developer and the like. However, from the viewpoint of easily adjusting the thickness of the liquid developer layer, a regulating member that regulates the thickness is preferably positioned on the upstream side (on the upstream side in a direction in which the developing member is driven) of a position at which the liquid developer is supplied to the surface of the image holding member. The position at which the regulating member is provided is preferably on the upstream side (on the upstream side in a direction in which the developing member is driven) of a position at which the developer charging unit further performs charging.

Volume Average Particle Diameter of Toner

The volume average particle diameter of the toner is preferably from 2.5 μm to 3.8 μm, and more preferably from 2.5 μm to 3.0 μm. When the volume average particle diameter is 2.5 μm or more, fogging and irregularities in contour parts of dots, that occur due to a too large toner amount, are suppressed. On the other hand, when the volume average particle diameter is 3.8 μm or less, the occurrence of voids in the image part due to the insufficient toner amount is suppressed.

When the volume average particle diameter (that is, a thickness of a toner layer corresponding to one layer) of the toner is within the above range, a high-quality image may be formed not only on a recording medium such as coating paper with suppressed surface roughness, but also on a recording medium such as plain paper having several micro meter-order surface roughness. When the volume average particle diameter is 2.5 μm or more, the toner is transferred along with a plain paper surface and the like and voids are thus suppressed in the image part. On the other hand, when the volume average particle diameter is 3.8 μm or less, the thickness of the toner layer does not become too large, and thus an image in which an embossed feeling is suppressed is formed.

The volume average particle diameter of the toner is controlled during the granulation of the toner.

Next, the liquid developing device and an image forming apparatus according to this exemplary embodiment will be described using the drawing.

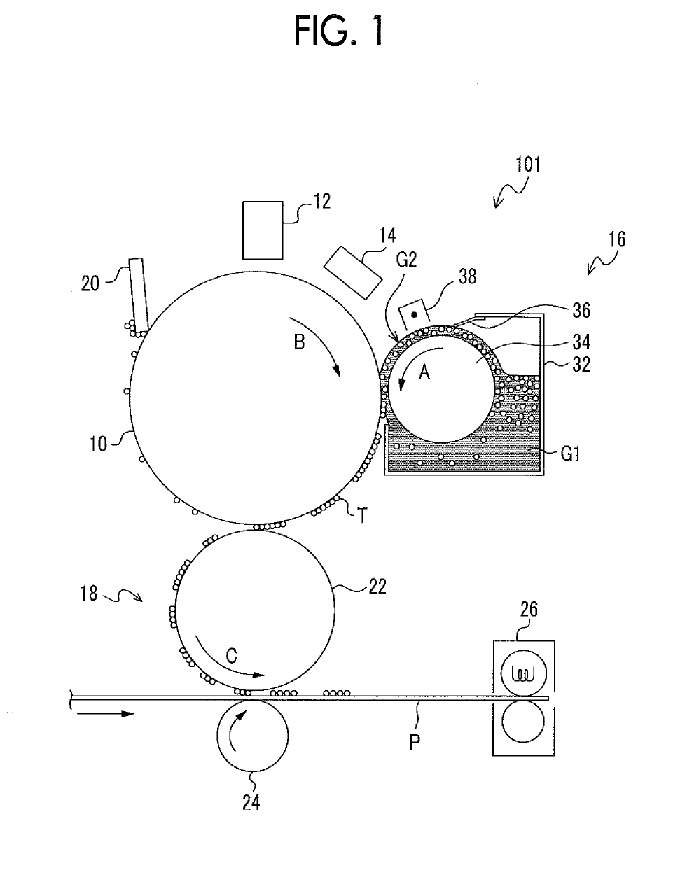

FIG. 1 is a schematic diagram illustrating a configuration of the image forming apparatus according to this exemplary embodiment. The image forming apparatus illustrated in FIG. 1 includes the liquid developing device according to this exemplary embodiment.

An image forming apparatus 101 according to this exemplary embodiment is, for example, a wet image forming apparatus as illustrated in FIG. 1, and includes a photoreceptor 10 (an example of the image holding member. In this exemplary embodiment, the image holding member is a member on which the liquid developing device forms a toner image). Around the photoreceptor 10, a photoreceptor charging device 12 that charges a surface of the photoreceptor 10, an exposure device 14 (an example of an electrostatic latent image forming device) that forms an electrostatic latent image on the charged surface of the photoreceptor 10 by exposure, a liquid developing device 16 that develops the electrostatic latent image formed on the surface of the photoreceptor 10 to form a toner image T, a transfer device 18 that transfers the toner image T formed on the surface of the photoreceptor 10 onto a surface of a recording medium P (for example, paper), a cleaner 20 that removes and collects transfer residual toner particles remaining on the surface of the photoreceptor 10 after transfer of the toner image T, and a fixing device 26 that fixes the toner image T transferred onto the surface of the recording medium P by heating are provided.

The transfer device 18 is configured from an intermediate transfer-type device including a drum-shaped intermediate transfer member 22 with a surface onto which the toner image T formed on the surface of the photoreceptor 10 is transferred and a transfer roll 24 that transfers the toner image T transferred onto the surface of the intermediate transfer member 22 onto a recording medium P.

The transfer device 18 may include, for example, a belt-shaped intermediate transfer member 22, or may not include the intermediate transfer member 22 but have a direct transfer system to directly transfer the toner image T onto a recording medium P from the photoreceptor 10 by the transfer roll 24.

FIG. 1 illustrates the fixing device 26 that fixes the toner image T transferred onto the surface of the recording medium P by heating. However, the fixing system of the fixing device 26 may be contact heat fixing using a fixing roll or a belt or non-contact heat fixing using an oven or a flash lamp. When using an ultraviolet curable developer, the fixing may be performed using a UV lamp or the like.

Next, an operation of the image forming apparatus 101 illustrated in FIG. 1 will be described.

In the image forming apparatus 101 according to this exemplary embodiment, first, the photoreceptor charging device 12 charges the surface of the photoreceptor 10 rotating in a direction of the arrow B to a preset potential.

Next, the exposure device 14 exposes the charged surface of the photoreceptor 10 (for example, exposure to laser beams) based on an image signal to form an electrostatic latent image.

Next, the liquid developing device 16 supplies a liquid developer G1 to the surface of the photoreceptor 10 on which the electrostatic latent image is formed, to develop (visualize) the electrostatic latent image, thereby forming a toner image T.

Next, the toner image T developed on the surface of the photoreceptor 10 is transferred onto the surface of the intermediate transfer member 22 rotating in a direction of the arrow C.

Next, the toner image T transferred onto the surface of the intermediate transfer member 22 is transferred onto a recording medium P at a position coming into contact with the transfer roll 24. Here, regarding the transfer, the recording medium P is sandwiched between the transfer roll 24 and the intermediate transfer member 22 and the toner image T on the surface of the intermediate transfer member 22 is brought into close contact with the recording medium P to transfer the toner image T onto the recording medium P.

Thereafter, the recording medium P onto which the toner image T is transferred is transported to the fixing device 26, sandwiched between a pair of fixing rollers in the fixing device 26, and pressed and heated at the same time, whereby the toner image T is fixed to the surface of the recording medium P. Accordingly, a fixed image is formed on the surface of the recording medium P.

The cleaner 20 removes and collects transfer residual toner particles on the photoreceptor 10 after the transfer of the toner image T onto the intermediate transfer member 22, and the process proceeds to the image forming process again.

Next, the liquid developing device 16 will be described.

The liquid developing device 16 is a wet developing device, and includes a developer accommodating container 32 (an example of the developer accommodating section) that accommodates a liquid developer G1, a developing roll 34 (an example of the developing member) to which the liquid developer G1 accommodated in the developer accommodating container 32 is supplied to a surface thereof to form a liquid developer layer G2, and the liquid developer layer G2 thus formed is supplied to the surface of the photoreceptor 10 to develop an electrostatic latent image formed on the surface of the photoreceptor 10 to thus form a toner image, a regulating member 36 that limits a supply amount of the liquid developer G1 that is supplied by the developing roll 34 to regulate a thickness of the liquid developer layer G2, and a developer charging device 38 (an example of the developer charging unit) that charges the liquid developer layer G2 before the liquid developer layer is supplied to the surface of the photoreceptor 10.

The developing roll 34 is provided to be partially dipped in the liquid developer G1 accommodated in the developer accommodating container 32.

As the developer charging device 38, a charging device using a corona discharger such as a corotron or a scorotron, a charging roller, a glow discharger, or the like may also be used.

An operation of the liquid developing device 16 will be described.

In the liquid developing device 16, the liquid developer C1 is supplied to the surface of the developing roll 34 at a position at which the developing roll 34 is dipped in the liquid developer G1 accommodated in the developer accommodating container 32, and the regulating member 36 limits a supply amount of the liquid developer G1 to form the liquid developer layer G2. At this time, the toner coverage that is obtained through the expression (1) is controlled within the above-described range.

Next, the developer charging device 38 charges the liquid developer layer G2 before the liquid developer layer is supplied to the surface of the photoreceptor 10. At this time, the toner in the liquid developer layer G2 is charged and pressed toward the developing member in the liquid developer layer G2.

Next, the liquid developer in the liquid developer layer G2 is supplied to the surface of the photoreceptor 10 at a position at which the developing roll 34 faces the photoreceptor 10, to develop (visualize) an electrostatic latent image on the surface of the photoreceptor 10 having the electrostatic latent image formed thereon, and thus a toner image T is formed.

Liquid Developer

Here, the liquid developer in this exemplary embodiment will be described.

The liquid developer contains at least a toner and a carrier liquid.

In this exemplary embodiment, the composition of the liquid developer is adjusted so that a toner coverage that is obtained through the expression (1) is within the above-described range. Specifically, the toner concentration of the liquid developer is from 23 vol % to 27 vol %. In addition, the volume average particle diameter of the toner is preferably from 2.5 μm to 3.8 μm.

Toner Particles

Toner particles contain, for example, a binder resin, and if necessary, a colorant, a release agent, and other additives. These additives may be internally added by being kneaded in the binder resin, or externally added by performing a mixing process after obtaining a toner as particles. The colorant is generally contained, but when a transparent toner is made, the colorant may not be contained.

Binder Resin

Examples of the binder resin include vinyl-based resins formed of homopolymers of monomers such as styrenes (e.g., styrene, p-chlorostyrene, and α-methylstyrene), (meth)acrylates (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene), or copolymers obtained by combining two or more kinds of these monomers.

As the binder resin, there are also exemplified non-vinyl-based resins such as epoxy resins, polyester resins, polyurethane resins, polyamide resins, cellulose resins, polyether resins, and modified rosin, mixtures thereof with the above-described vinyl-based resins, or graft polymers obtained by polymerizing a vinyl-based monomer with the coexistence of such non-vinyl-based resins.

These binder resins may be used singly or in combination of two or more kinds thereof.

A polyester resin is preferable as the binder resin.

Examples of the polyester resin include known amorphous polyester resins. Regarding the polyester resin, a crystalline polyester resin may be used in combination together with an amorphous polyester resin. The content of the crystalline polyester resin may be from 2% by weight to 40% by weight (preferably from 2% by weight to 20% by weight) with respect to the entire binder resin.

The “crystalline” resin indicates that the resin does not exhibit a stepwise change in endothermic quantity, but has a definite endothermic peak in differential scanning calorimetry (DSC). Specifically, the “crystalline” resin indicates that the half-value width of the endothermic peak in the measurement at a rate of temperature increase of 10(° C./min) is within 10° C.

On the other hand, the “amorphous” resin indicates that the half-value width is more than 10° C., a stepwise change in endothermic quantity is shown, or a definite endothermic peak is not recognized.

Amorphous Polyester Resin

Examples of the amorphous polyester resin include a condensation polymer of a polyvalent carboxylic acid and a polyol. A commercially available product or a synthesized product may be used as the amorphous polyester resin.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), and anhydrides or lower alkyl esters (having, for example, from 1 to 5 carbon atoms) thereof. Among these, for example, aromatic dicarboxylic acids are preferable as the polyvalent carboxylic acid.

Regarding the polyvalent carboxylic acid, a tri- or higher-valent carboxylic acid having a crosslinked structure or a branched structure may be used in combination together with a dicarboxylic acid. Examples of the tri- or higher-valent carboxylic acid include trimellitic acid, pyromellitic acid, and anhydrides or lower alkyl esters (having, for example, from 1 to 5 carbon atoms) thereof.

The polyvalent carboxylic acids may be used singly or in combination of two or more kinds thereof.

Examples of the polyol include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adduct of bisphenol A and propylene oxide adduct of bisphenol A). Among these, for example, aromatic dials and alicyclic dials are preferable, and aromatic diols are more preferable as the polyol.

As the polyol, a tri- or higher-valent polyol having a crosslinked structure or a branched structure may be used in combination together with diol. Examples of the tri- or higher-valent polyol include glycerin, trimethylolpropane, and pentaerythritol.

The polyols may be used singly or in combination of two or more kinds thereof.

The glass transition temperature (Tg) of the amorphous polyester resin is preferably from 50° C. to 80° C., and more preferably from 50° C. to 65° C.

The glass transition temperature is obtained from a DSC curve obtained by differential scanning calorimetry (DSC). More specifically, the glass transition temperature is obtained from “extrapolated glass transition onset temperature” described in the method of obtaining a glass transition temperature in “testing methods for transition temperatures of plastics” in JIS K-1987.

The weight average molecular weight (Mw) of the amorphous polyester resin is preferably from 5,000 to 1,000,000, and more preferably from 7,000 to 500,000.

The number average molecular weight (Mn) of the amorphous polyester resin is preferably from 2,000 to 100,000.

The molecular weight distribution Mw/Mn of the amorphous polyester resin is preferably from 1.5 to 100, and more preferably from 2 to 60.

The weight average molecular weight and the number average molecular weight are measured by gel permeation chromatography (GPC). The molecular weight measurement by GPC is performed using HLC-8120 which is GPC manufactured by Tosoh Corporation as a measuring device, TSK gel Super HM-M (15 cm) which is a column manufactured by Tosoh Corporation, and a THF solvent. The weight average molecular weight and the number average molecular weight are calculated using a molecular weight calibration curve plotted from the results of the above measurement using a monodisperse polystyrene standard sample.

A known manufacturing method is used to manufacture the amorphous polyester resin. Specific examples thereof include a method of causing a reaction at a polymerization temperature set to from 180° C. to 230° C., if necessary, under reduced pressure in the reaction system, while removing water or an alcohol that is generated during condensation.

When monomers of the raw materials are not dissolved or compatibilized under a reaction temperature, a high-boiling-point solvent may be added as a solubilizing agent to dissolve the monomers. In this case, a polycondensation reaction is caused while distilling away the solubilizing agent. When a monomer having poor compatibility is present in the copolymerization reaction, the monomer having poor compatibility and an acid or an alcohol to be polycondensed with the monomer may be previously condensed and then polycondensed with the main component.

Crystalline Polyester Resin

Examples of the crystalline polyester resin include a polycondensate of a polyvalent carboxylic acid and a polyol. A commercially available product or a synthesized product may be used as the crystalline polyester resin.

Here, as the crystalline polyester resin, a polycondensate using a polymerizable monomer having a linear aliphatic group is preferably used rather than a polymerizable monomer having an aromatic group, in order to easily form a crystal structure.

Examples of the polyvalent carboxylic acid include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids such as phthalic acid, isophthalic acid, terephthalic acid, naphthalene-2,6-dicarboxylic acid, malonic acid, and mesaconic acid), and anhydrides or lower alkyl esters (having, for example, from 1 to 5 carbon atoms) thereof.

Regarding the polyvalent carboxylic acid, a tri- or higher-valent carboxylic acid having a crosslinked structure or a branched structure may be used in combination together with a dicarboxylic acid. Examples of the trivalent carboxylic acid include aromatic carboxylic acids (e.g., 1,2,3-benzenetricarboxylic acid, 1,2,4-benzenetricarboxylic acid, and 1,2,4-naphthalenetricarboxylic acid), and anhydrides or lower alkyl esters (having, for example, from 1 to 5 carbon atoms) thereof.

As the polyvalent carboxylic acid, a dicarboxylic acid having a sulfonic acid group or a dicarboxylic acid having an ethylenic double bond may be used in combination together with these dicarboxylic acids.

The polyvalent carboxylic acids may be used singly or in combination of two or more kinds thereof.

Examples of the polyol include aliphatic diols (e.g., linear aliphatic diols having from 7 to 20 carbon atoms in a main chain part). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, 1,8-octanediol, 1,9-nonanediol, and 1,10-decanediol are preferable as the aliphatic diol.

Regarding the polyol, a tri- or higher-valent polyol having a crosslinked structure or a branched structure may be used in combination together with diol. Examples of the tri- or higher-valent polyol include glycerin, trimethylolethane, trimethylolpropane, and pentaerythritol.

The polyols may be used singly or in combination of two or more kinds thereof.

Here, in the polyol, the content of the aliphatic diol may be 80 mol % or more, and is preferably 90 mol % or more.

The melting temperature of the crystalline polyester resin is preferably from 50° C. to 100° C., more preferably from 55° C. to 90° C., and even more preferably from 60° C. to 85° C.

The melting temperature is obtained from “melting peak temperature” described in the method of obtaining a melting temperature in “testing methods for transition temperatures of plastics” in JIS K-1987, from a DSC curve obtained by differential scanning calorimetry (DSC).

The weight average molecular weight (Mw) of the crystalline polyester resin is preferably from 6,000 to 35,000.

For example, a known manufacturing method is used to manufacture the crystalline polyester resin as in the case of the amorphous polyester resin.

The content of the binder resin is, for example, preferably from 40% by weight to 95% by weight, more preferably from 50% by weight to 90% by weight, and even more preferably from 60% by weight to 85% by weight with respect to all of the toner particles.

Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, Rhodamine B Lake, Lake Red C, pigment red, rose bengal, aniline blue, ultramarine blue, calco oil blue, methylene blue chloride, phthalocyanine blue, pigment blue, phthalocyanine green, and malachite green oxalate, and various dyes such as acridine-based dyes, xanthene-based dyes, azo-based dyes, benzoquinone-based dyes, azine-based dyes, anthraquinone-based dyes, thioindigo-based dyes, dioxadine-based dyes, thiazine-based dyes, azomethine-based dyes, indigo-based dyes, phthalocyanine-based dyes, aniline black-based dyes, polymethine-based dyes, triphenylmethane-based dyes, diphenylmethane-based dyes, and thiazole-based dyes.

The colorants may be used singly or in combination of two or more kinds thereof.

If necessary, the colorant may be surface-treated or used in combination with a dispersant. Plural kinds of colorants may be used in combination.

The content of the colorant is, for example, preferably from 1% by weight to 30% by weight, and more preferably from 3% by weight to 15% by weight with respect to all of the toner particles.

Release Agent

Examples of the release agent include hydrocarbon-based waxes; natural waxes such as carnauba wax, rice wax, and candelilla wax; synthetic or mineral/petroleum-based waxes such as montan wax; and ester-based waxes such as fatty acid esters and montanic acid esters. The release agent is not limited thereto.

The melting temperature of the release agent is preferably from 50° C. to 110° C., and more preferably from 60° C. to 100° C.

The melting temperature is obtained from “melting peak temperature” described in the method of obtaining a melting temperature in “testing methods for transition temperatures of plastics” in JIS K-1987, from a DSC curve obtained by differential scanning calorimetry (DSC).

The content of the release agent is, for example, preferably from 1% by weight to 20% by weight, and more preferably from 5% by weight to 15% by weight with respect to all of the toner particles.

Other Additives

Examples of other additives include known additives such as a charge-controlling agent and an inorganic powder. The toner particles include these additives as internal additives.

Toner Manufacturing Method

The method of manufacturing the toner that is used in this exemplary embodiment is not particularly limited. For example, the toner is obtained by finely pulverizing, in a carrier liquid, a pulverized toner, a dried toner that is emulsified in a liquid, or a toner that is manufactured using a polymerized toner manufacturing method.

For example, a binder resin, a colorant, and other additives are put into and mixed in a mixer such as a Henschel mixer, and the mixture is melted and kneaded using a twin-screw extruder, a Banbury mixer, a roll mill, a kneader or the like and then cooled using a drum flaker or the like. The cooled material is coarsely pulverized using a pulverizer such as a hammer mill and finely pulverized using a pulverizer such as a jet mill. Then, the pulverized material is classified using an air classifier or the like, whereby a pulverized toner is obtained.

In addition, a binder resin, a colorant, and other additives are dissolved in a solvent such as ethyl acetate, and emulsified and suspended in water containing a dispersion stabilizer such as calcium carbonate. After removing the solvent, the dispersion stabilizer is removed and the obtained particles are filtered and dried, whereby a dried toner that is emulsified in a liquid is obtained.

In addition, a composition containing a polymerizable monomer that forms a binder resin, a colorant, a polymerization initiator, and other additives is added and granulated in an aqueous phase under stirring. After causing a polymerization reaction, the particles are filtered and dried, whereby a polymerized toner is obtained.

The obtained toner is finely pulverized in a carrier liquid using a known pulverizing device such as a ball mill, a bead mill, and a high-pressure wet atomizing device to obtain toner particles for a liquid developer according to this exemplary embodiment.

From the viewpoint of more easily adjusting the toner coverage within the above-described range, a toner in which “upper GSD_{V}” and “lower GSD_{P}” in a toner particle size distribution are less than 1.3 is preferably used. When the upper GSD_{V} and the lower GSD_{P} are in the above range, higher image quality is obtained as compared with the case of a toner having a wider particle size distribution.

Here, “upper GSD_{V}” is a volume particle size distribution on the coarse powder side and is expressed as (D16_{V}/D50_{V}). “Lower GSD_{P}” is a number particle size distribution on the fine powder side and is expressed as (D50_{P}/D84_{P}).

The method of measuring the upper GSD_{V} and the lower GSD_{P} will be described. The measurement is performed using a laser diffraction/scattering-type particle size distribution measurement device (for example, LA920 (manufactured by Horiba, Ltd.)). A cumulative distribution is drawn for each of volume and number from the smallest diameter side with respect to particle size ranges (channels) divided based on the particle size distribution. A particle diameter when the cumulative percentage becomes 16% is defined as that corresponding to volume D16_{V} and number D16_{P}, a particle diameter when the cumulative percentage becomes 50% is defined as that corresponding to volume D50_{V} and number D50_{P}, and a particle diameter when the cumulative percentage becomes 84% is defined as that corresponding to volume D84_{V} and number D84_{P}. Using these, the upper GSD_{V} and the lower GSD_{P} are calculated.

Carrier Liquid

The carrier liquid is preferably an insulating liquid containing a silicone oil as a main component. The carrier liquid may be a single silicone oil or a mixture with other insulating liquids. Examples of the silicone oil include KF96 (Shin-Etsu Chemical Co., Ltd.), SH200 and SH344 (Dow Corning Toray Silicone Co., Ltd.), and TSF451 (Toshiba Silicone Co., Ltd.).

Other than the silicone oil, for example, an aliphatic hydrocarbon solvent such as paraffin oil (examples of commercially available products thereof include MORESCO WHITE MT-30P, MORESCO WHITE P40 and MORESCO WHITE P70 all manufactured by Matsumura Sekiyu Co., Ltd., and ISOPAR L and ISOPAR M all manufactured by Exon Chemical Co., Ltd.), and a hydrocarbon-based solvent such as naphthene oil (examples of commercially available products thereof include EXOL D80, EXOL D110 and EXOL D130 all manufactured by Exon Chemical Co., Ltd., and NAPHTESOL L, NAPHTESOL M, NAPHTESOL H, New NAPHTESOL 160, New NAPHTESOL 200, New NAPHTESOL 220 and New NAPHTESOL MS-20P all manufactured by Nippon Petrochemicals Co., Ltd.) may be used and an aromatic compound such as toluene may also be incorporated in them.

These liquids other than the silicone oil may be used by mixing with the silicone oil.

The carrier liquid contained in the liquid developer according to this exemplary embodiment may be composed of one kind, or a mixture of two or more kinds may also be used.

The carrier liquid may contain various subsidiary materials such as a dispersant, an emulsifier, a surfactant, a stabilizer, a wetting agent, a thickener, a foaming agent, an antifoamer, a coagulating agent, a gelling agent, a precipitation preventing agent, a charge-controlling agent, an antistatic agent, an aging preventing agent, a softening agent, a plasticizer, a filler, a reodorant, an adhesion preventing agent, and a release agent.

Liquid Developer Manufacturing Method

The liquid developer is obtained by mixing the toner particles and the carrier liquid described above using a dispersing machine such as a ball mill, a sand mill, an attritor, or a bead mill, pulverizing the mixture, and dispersing the toner particles in the carrier liquid.

The dispersion of the toner particles in the carrier liquid is not limited to the dispersing machine. The dispersion may be carried out by rotating a special stirring blade at a high speed as in the case of using a mixer, may be carried out with a shearing force of a rotor-stator that is known as a homogenizer, or may be carried out using ultrasonic waves.

Liquid Developing Method and Image Forming Method

A liquid developing method according to this exemplary embodiment that is performed using the above-described liquid developing device according to this exemplary embodiment include a liquid developer layer forming process of supplying a liquid developer that contains a toner and a carrier liquid and has a toner concentration of 23 vol. % to 27 vol % to a surface of a developing member to form a liquid developer layer with a thickness of from 5.8 μm to 7.5 μm, of which a toner coverage that is obtained through the following expression (1) is from 0.71 to 1.1, a developer charging process of charging the liquid developer layer, and a developing process of supplying the liquid developer layer to a surface of an image holding member having an electrostatic latent image formed on the surface thereof to develop the electrostatic latent image to thus form a toner image, in this order.

Toner Coverage=({S_{V}L/(4πr³/3)}×πr²)/0.9069 Expression (1):

In the expression (1), S_{V} represents a toner concentration (vol %/100) in the liquid developer, L represents a thickness (μm) of the liquid developer layer, and r represents a volume average particle radius (μm) of the toner. 0.9069 that is the above numerical value is a closest area filling rate of circles.

In addition, an image forming method according to this exemplary embodiment includes a charging process of charging an image holding member, an electrostatic latent image forming process of forming an electrostatic latent image on a charged image holding member, a liquid developing process of developing the electrostatic latent image formed on the surface of the image holding member using the liquid developing method according to this exemplary embodiment to form a toner image, a transfer process of transferring the toner image formed on the surface of the image holding member onto a surface of a recording medium, and a fixing process of fixing the toner image transferred onto the surface of the recording medium to the surface of the recording medium.

According to the liquid developing method and the image forming method according to this exemplary embodiment, an image having excellent image quality may be formed.

### EXAMPLES

Hereinafter, the exemplary embodiments will be described in more detail using examples, but are not limited to the following examples. In the following description, “parts” is based on the weight unless otherwise noted.

Methods of Measuring Various Characteristics

First, methods of measuring physical properties of the toner used in examples and comparative examples will be described.

Molecular Weight of Resin

The molecular weight of a resin is measured under the following conditions. “HLC-8120GPC and SC-8020 (manufactured by Tosoh Corporation)” are used as devices for GPC, two columns “TSK gel, Super HM-M (manufactured by Tosoh Corporation, 6.0 mm ID×15 cm) are used, and tetrahydrofuran (THF) is used as an eluent. The experiment is performed using a refractive index (RI) detector under the experimental conditions of a sample concentration of 0.5% by weight, a flow rate of 0.6 ml/min, a sample injection amount of 10 μl, and a measurement temperature of 40° C. In addition, a standard curve is drawn from 10 samples of “polystylene standard sample TSK standard”: “A-500”, “F-1”, “F-10”, “F-80”, “F-380”, “A-2500”, “F-4”, “F-40”, “F-128”, and “F-700”.

Volume Average Particle Diameters of Toner, Resin Particles, Colorant Particles, Etc.

The volume average particle diameters of a toner, resin particles, colorant particles, etc. are measured using a laser diffraction/scattering-type particle size distribution measurement device (for example, LA920 (manufactured by Horiba, Ltd.)). A cumulative distribution is drawn for volume from the smallest diameter side with respect to particle size ranges (channels) divided based on the particle size distribution, and a particle diameter when the cumulative percentage becomes 50% is defined as that corresponding to volume D50_{V}.

Glass Transition Temperature and Melting Temperature of Resin

A glass transition temperature (Tg) and a melting temperature (Tm) are obtained from respective maximum peaks measured based on ASTMD 3418-8. A temperature at an intersection between extended lines of a base line and a rising line in a heat-absorbing part is used as the glass transition temperature, and a temperature at an apex of a heat-absorbing peak is used as the melting temperature. In the measurement, a differential scanning calorimeter (DSC-7, manufactured by PerkinElmer Co., Ltd.) is used.

### Example 1

### Preparation of Liquid Developer

A toner for a liquid developer is prepared using the following method.

Toner Manufacturing Method

Manufacturing of Toner (1)

### Preparation of Amorphous Polyester Resin (1) and Amorphous Resin Particle Dispersion (1a)

polyoxyethylene
(2,0)-2,2-bis(4-hydroxyphenyl)propane: 35 molar parts polyoxypropylene
(2,2)-2,2-bis(4-hydroxyphenyl)propane: 65 molar parts
terephthalic acid: 80 molar parts
n-dodecenyl succinic acid: 15 molar parts
trimellitic acid: 10 molar parts

A two-necked flask dried by heating is charged with the above materials and dibutyltin oxide in an amount of 0.05 molar part with respect to these acid components (total mol number of the terephthalic acid, n-dodecenyl succinic acid, and trimellitic acid), nitrogen gas is supplied into the container to maintain an inert atmosphere, and the temperature is raised. Then, a copolycondensation is caused for 12 hours at from 150° C. to 230° C., and then the pressure is gradually reduced at from 210° C. to 250° C. to synthesize an amorphous polyester resin (1).

The weight average molecular weight (Mw) of the amorphous polyester resin (1) that is obtained through the molecular weight measurement (in terms of polystyrene) by gel permeation chromatography (GPC) is 15,000 and a number average molecular weight (Mn) of 6,800.

When the measurement is performed on the amorphous polyester resin (1) using a differential scanning calorimeter (DSC), a definite peak is not shown, but a stepwise change in endothermic quantity is observed. The glass transition temperature that is a temperature at the midpoint of the stepwise change in endothermic quantity is 62° C.

3,000 parts of the obtained amorphous polyester resin (1), 10,000 parts of ion exchange water, and 90 parts of a surfactant (sodium dodecylbenzenesulfonate) are put into an emulsion tank of a high-temperature high-pressure emulsion device (Cavitron CD1010, slit: 0.4 mm). Thereafter, the materials are melted by heating to 130° C. and dispersed for 30 minutes at 110° C., a flow rate of 3 L/m, and 10,000 rpm. The obtained material is allowed to pass through a cooling tank to collect the resin particle dispersion, whereby an amorphous resin particle dispersion (1a) is obtained.

The resin particles contained in the obtained amorphous resin particle dispersion (1a) have a volume average particle diameter D50_{V} of 0.3 μm and a standard deviation of 1.2.

Preparation of Crystalline Polyester Resin (2) and Crystalline Resin Particle Dispersion (2a)

1,4-butanediol (manufactured by Wako Pure Chemical Industries, Ltd.): 293 parts

dodecane dicarboxylic acid (manufactured by Wako Pure Chemical Industries, Ltd.): 750 parts

catalyst (dibutyltin oxide): 0.3 part

A three-necked flask dried by heating is charged with the above materials, and then the air in the container is put under an inert atmosphere with nitrogen gas through a decompression operation. The components are stirred for 2 hours at 180° C. by mechanical stirring. Thereafter, the temperature is gradually increased to 230° C. under the reduced pressure and the stirring is performed for 5 hours. When the obtained material becomes viscous, air cooling is performed to stop the reaction, and thus a crystalline polyester resin (2) is synthesized.

The weight average molecular weight (Mw) of the crystalline polyester resin (2) that is obtained through the molecular weight measurement (in terms of polystyrene) by gel permeation chromatography (GPC) is 18,000.

In addition, when the melting temperature (Tm) of the crystalline polyester resin (2) is measured through the above-described measurement method using a differential scanning calorimeter (DSC), a definite peak is shown and the temperature of the peak top is 70° C.

A crystalline resin particle dispersion (2a) is prepared under the same conditions as for the resin particle dispersion (1a), except that the crystalline polyester resin (2) is used in place of the amorphous polyester resin (1). The particles contained in the obtained dispersion have a volume average particle diameter D50_{V} of 0.25 μm and a standard deviation of 1.3.

Preparation of Colorant Dispersion (1)

Phthalocyanine Pigment (Manufactured by Dainichiseika Color & Chemicals Mfg. Co., Ltd., PVFASTBLUE): 25 parts

anionic surfactant (manufactured by Dai-Ichi Kogyo Seiyaku Co., Ltd., Neogen RK): 2 parts

ion exchange water: 125 parts

The above components are mixed and then dispersed using a homogenizer (manufactured by IKA-Werke GmbH & Co. KG., Ultra Turrax) to obtain a colorant dispersion (1).

Preparation of Release Agent Particle Dispersion (1)

pentaerythritol behenic acid tetraester wax: 100 parts

anionic surfactant (manufactured by NON Corporation, New Rex R): 2 parts

ion exchange water: 300 parts

The above components are mixed and dispersed using a homogenizer (manufactured by IKA-Werke GmbH & Co. KG., Ultra Turrax). Then, the obtained material is subjected to a dispersion treatment using a pressure discharge-type homogenizer, whereby a release agent particle dispersion (1) is obtained.

Preparation of Inorganic Particle Dispersion (1)

hydrophobic silica (manufactured by Nippon Aerosil Co., Ltd., RX200): 100 parts

anionic surfactant (manufactured by NOF Corporation, New Rex R): 2 parts

ion exchange water: 1,000 parts

The above components are mixed and dispersed using a homogenizer (manufactured by INA-Werke GmbH & Co. KG., Ultra Turrax). Then, the obtained material is subjected to 200 pass-dispersion using an ultrasonic homogenizer (RUS-600CCVP, Nippon Seiki Co., Ltd.), whereby an inorganic particle dispersion (1) is obtained.

Preparation of Toner (1)

amorphous resin particle dispersion (1a): 145 parts

crystalline resin particle dispersion (2a): 30 parts

colorant dispersion (1): 42 parts

release agent particle dispersion (1): 36 parts

inorganic particle dispersion (1): 10 parts

aluminum sulfate (manufactured by Wako Pure Chemical Industries, Ltd.): 0.5 parts

ion exchange water: 300 parts

The above components are accommodated in a round stainless steel flask and the pH is adjusted to pH 2.7. The components are dispersed using a homogenizer (manufactured by IKA-Werke GmbH & Co. KG., Ultra Turrax T50), and then heated to 47° C. under stirring in a heating oil bath. The obtained material is kept at 47° C. for 60 minutes, and then 46 parts of the amorphous resin particle dispersion (1a) is gently added thereto. Thereafter, a 0.55 N sodium hydroxide aqueous solution is gently added thereto to adjust the pH to 9.0, and then the obtained material is heated to 90° C. under stirring and kept for 3.5 hours. Thereafter, the reaction product is filtered, washed with ion exchange water, and then dried using a vacuum dryer to obtain toner particles (1).

1 part of a gas phase silica (manufactured by Nippon Aerosil Co., Ltd., R972) is mixed and externally added with respect to 100 parts of the toner particles using a Henschel mixer, and thus a toner (1) is obtained.

Preparation of Liquid Developer

The obtained toner (1) and a carrier liquid (silicone oil, manufactured by Shin-Etsu Chemical Co., Ltd., product name: KF-96-20cs) are mixed so as to adjust a toner concentration to the value described in Table 1, whereby a liquid developer 1 is obtained.

The volume average particle diameter (D50_{V}) and the toner concentration (vol %) of the toner in the obtained liquid developer are measured using the above-described methods. The results are shown in the following Table 1.

Image Formation

First, an image forming apparatus (manufactured by Miyakoshi Co., Ltd., product name: MDP1260) having a configuration illustrated in FIG. 1 and a charging device for a liquid developer layer is prepared.

A developer accommodating container of the image forming apparatus is charged with the obtained liquid developer 1, A regulating member that regulates a supply amount of the liquid developer is adjusted so that the thickness of a liquid developer layer is adjusted to the value of the following Table 1.

The following evaluation tests are then performed using this image forming apparatus.

Evaluation Tests

Circularity

The image forming apparatus prints a dot image in which 12 pixel dot clusters are arranged, and the circularity in the dot image is measured using the following method.

Regarding the measurement of the circularity, an average value of radius ratios of 30 dots is measured using Image-Pro PLUS (manufactured by Media Cybernetics, Inc.) and is set as the circularity.

When the circularity is 2.00 or less, it is regarded that no problems occur.

Void Evaluation

In the dot image created in the circularity evaluation test, in which 12 pixel dot clusters are arranged, the circularity deteriorates and is more than 2.00 when voids are caused. Accordingly, when the circularity is more than 2.00, it is regarded that voids are caused.

Fogging Evaluation

In the dot image created in the circularity evaluation test, in which 12 pixel dot clusters are arranged, the presence or absence of fogging is evaluated with the following evaluation grades.

When the grade is two or lower, it is regarded that no problems occur.

Grade 1: Fogging is not observed (there are absolutely no problems)

Grade 2: Fogging is observed, but this level has no problems.

Grade 3: Fogging is observed, and this level has problems.

### Examples 2 and 3, Comparative Example 1

The preparation conditions of the “Preparation of Toner (1)” in Example 1 are adjusted to prepare a toner of which the particle diameter (D50_{V}), the upper GSD_{V}, and the lower GSD_{P} are adjusted to the values of the following Table 1. The regulating member in the image forming apparatus is adjusted so that the thickness of a liquid developer layer is adjusted to the value of the following Table 1.

Except for these, the evaluation tests are performed using the methods described in Example 1.

In the following Tables 1 to 4, the column in which “-” is displayed represents that the measurement and the evaluation test are not carried out.

TABLE 1

| | | Toner | | | | Thickness | | | |
|---|---|---|---|---|---|---|---|---|---|
| | | Particle | Upper | Lower | | of Liquid | | | |
| | | Diameter | GSDᵥ | GSDₚ | Toner | Developer | Evaluation | | |
| | Toner | D50ᵥ | of | of | Concentration | Layer | | Void | Fogging |
| | Coverage | (μm) | Toner | Toner | (vol %) | (μm) | Circularity | Evaluation | Evaluation |
| Example 1 | 0.98 | 2.5 | 1.254 | 1.234 | 23 | 6.5 | 1.43 | None | 1 |
| Example 2 | 1.05 | 2.7 | 1.264 | 1.236 | 23 | 7.5 | 1.9 | None | 1 |
| Example 3 | 0.87 | 2.6 | 1.295 | 1.248 | 23 | 6.0 | 1.44 | None | 1 |
| Comparative | 0.70 | 3.8 | — | — | 23 | 7.0 | 3.66 | Caused | 1 |
| Example 1 | | | | | | | | | |

### Example 4 and Comparative Examples 2 and 3

The preparation conditions of the “Preparation of Toner (1)” and the “Preparation of Liquid Developer” in Example 1 are adjusted to prepare a liquid developer of which the toner particle diameter (D50_{V}) and the toner concentration are adjusted to the values of the following Table 2. The regulating member in the image forming apparatus is adjusted so that the thickness of a liquid developer layer is adjusted to the value of the following Table 2.

Except for these, the evaluation tests are performed using the methods described in Example 1.

TABLE 2

| | | Toner | | Thickness | | |
|---|---|---|---|---|---|---|
| | | Particle | | of Liquid | | |
| | | Diameter | Toner | Developer | Evaluation | |
| | Toner | D50ᵥ | Concentration | Layer | Void | Fogging |
| | Coverage | (μm) | (vol %) | (μm) | Evaluation | Evaluation |
| Comparative | 0.34 | 3.8 | 15 | 5.3 | Caused | 1 |
| Example 2 | | | | | | |
| Example 4 | 0.76 | 3.8 | 27 | 6.5 | None | 1 |
| Comparative | 0.74 | 3.8 | 31 | 5.5 | None | 3 |
| Example 3 | | | | | | |

### Examples 5 to 7 and Comparative Example 4

The preparation conditions of the “Preparation of Toner (1)” in Example 1 are adjusted to prepare a toner of which the particle diameter (D50_{V}) is adjusted to the value of the following Table 3. The regulating member in the image forming apparatus is adjusted so that the thickness of a liquid developer layer is adjusted to the value of the following Table 3.

Except for these, the evaluation tests are performed using the methods described in Example 1.

Evaluation Test

Linear Disturbance

In the dot image created in the circularity evaluation test, in which 12 pixel dot clusters are arranged, the presence or absence of linear disturbance is evaluated.

TABLE 3

| | | Toner | | Thickness | | |
|---|---|---|---|---|---|---|
| | | Particle | | of Liquid | | |
| | | Diameter | Toner | Developer | Evaluation | |
| | Toner | D50ᵥ | Concentration | Layer | Void | Linear |
| | Coverage | (μm) | (vol %) | (μm) | Evaluation | Disturbance |
| Example 5 | 0.73 | 3.0 | 23 | 5.8 | None | None |
| Example 6 | 0.91 | 2.5 | 23 | 6.0 | None | None |
| Example 7 | 1.05 | 2.7 | 23 | 7.5 | None | None |
| Comparative | 1.02 | 3.0 | 23 | 8.1 | None | Caused |
| Example 4 | | | | | | |

### Examples 8 to 10 and Comparative Example 5

The preparation conditions of the “Preparation of Toner (1)” in Example 1 are adjusted to prepare a toner of which the particle diameter (D50_{V}), the upper GSD_{V}, and the lower GSD_{P} are adjusted to the values of the following Table 4. The regulating member in the image forming apparatus is adjusted so that the thickness of a liquid developer layer is adjusted to the value of the following Table 4.

Except for these, the evaluation tests are performed using the methods described in Example 1.

TABLE 4

| | | Toner | | | | Thickness | | | |
|---|---|---|---|---|---|---|---|---|---|
| | | Particle | Upper | Lower | | of Liquid | | | |
| | | Diameter | GSDᵥ | GSDₚ | Toner | Developer | Evaluation | | |
| | Toner | D50ᵥ | of | of | Concentration | Layer | | Void | Fogging |
| | Coverage | (μm) | Toner | Toner | (vol %) | (μm) | Circularity | Evaluation | Evaluation |
| Comparative | 0.68 | 3.9 | — | — | 23 | 7.0 | 3.66 | Caused | 1 |
| Example 5 | | | | | | | | | |
| Example 8 | 0.73 | 3.0 | 1.294 | 1.337 | 23 | 5.8 | 1.55 | None | 1 |
| Example 9 | 0.87 | 2.6 | 1.295 | 1.248 | 23 | 6.0 | 1.44 | None | 1 |
| Example 10 | 0.98 | 2.5 | 1.254 | 1.234 | 23 | 6.5 | 1.43 | None | 1 |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A liquid developing device comprising:
a developer accommodating section that accommodates a liquid developer containing a toner and a carrier liquid and having a toner concentration of from 23 vol % to 27 vol %;
a developing member to which the liquid developer accommodated in the developer accommodating section is supplied to a surface thereof to form a liquid developer layer with a thickness of from 5.8 μm to 7.5 μm, of which a toner coverage that is obtained through the following expression (1) is from 0.71 to 1.1, and the liquid developer layer thus formed is supplied to a surface of an image holding member to develop an electrostatic latent image formed on the surface of the image holding member to thus form a toner image; and
a developer charging unit that charges the liquid developer layer before the liquid developer layer is supplied to the surface of the image holding member,
Toner Coverage=({S_{V}L/(4πr³/3)}×πr²)/0.9069 Expression (1):
wherein in the expression (1), S_{V} represents a toner concentration (vol %/100) in the liquid developer; L represents a thickness (μm) of the liquid developer layer; and r represents a volume average particle radius (μm) of the toner; 0.9069 that is the above numerical value is a closest area filling rate of circles.

2. The liquid developing device according to claim 1,
wherein the toner in the liquid developer has a volume average particle diameter of from 2.5 μm to 3.8 μm.

3. The liquid developing device according to claim 1,
wherein the toner in the liquid developer has a volume average particle diameter of from 2.5 μm to 3.0 μm.

4. An image forming apparatus comprising:
an image holding member;
a charging device that charges the image holding member;
an electrostatic latent image forming device that forms an electrostatic latent image on a charged image holding member;
the liquid developing device according to claim 1 that develops the electrostatic latent image formed on a surface of the image holding member as a toner image;
a transfer device that transfers the toner image formed on the surface of the image holding member onto a surface of a recording medium; and
a fixing device that fixes the toner image transferred onto the surface of the recording medium to the surface of the recording medium.

5. An image forming apparatus comprising:
an image holding member;
a charging device that charges the image holding member;
an electrostatic latent image forming device that forms an electrostatic latent image on a charged image holding member;
the liquid developing device according to claim 2 that develops the electrostatic latent image formed on a surface of the image holding member as a toner image;
a transfer device that transfers the toner image formed on the surface of the image holding member onto a surface of a recording medium; and
a fixing device that fixes the toner image transferred onto the surface of the recording medium to the surface of the recording medium.

6. An image forming apparatus comprising:
an image holding member;
a charging device that charges the image holding member;
an electrostatic latent image forming device that forms an electrostatic latent image on a charged image holding member;
the liquid developing device according to claim 3 that develops the electrostatic latent image formed on a surface of the image holding member as a toner image;
a transfer device that transfers the toner image formed on the surface of the image holding member onto a surface of a recording medium; and
a fixing device that fixes the toner image transferred onto the surface of the recording medium to the surface of the recording medium.
